(19) United States
(12) Patent Application Publication
(10) Pub. No.: US 2005/0184409 A1
(43) Pub. Date: Aug. 25, 2005

(54) Decorative mirror and a process of manufacturing it

(76) Inventors: Andrey Volkov, Moscow (RU); Vladimir Subach, Lexington, MA (US)

Correspondence Address: Vladimir Subach, 18 April Lane, Lexington, MA, 02421, US

(21) Appl. No.: 10/785,170

(22) Filed: Feb. 23, 2004

(51) Int. Cl. B29D 11/00

(52) U.S. Cl. 264/1.9

(57) ABSTRACT

A decorative mirror features several overlapping and non-continuous reflective metallic layers with different reflective properties deposited on a transparent substrate. Areas where upper layers are visible through voids in the lower layers make patterns that can be alphanumerical, or ornamental, or artistic, or a combination of all for informational and decorative purposes. In order to manufacture the mirror a mask preventing metal deposition is applied before every layer is deposited. The mask is removed after the layer is deposited thus making upper layers visible through the voids in the lower layers. Reflective layers may be protected with further layers, for example of varnish or paint.

### BACKGROUND OF INVENTION

1. Field of Invention

This invention relates to a decorative mirror comprising overlapping reflective layers with different reflective properties deposited on a transparent sheet. The invention includes a process of manufacturing a decorative mirror that consists of application of metallic layers over removable masks that prevent deposition of a metal.

2. Description of Prior Art

Plain or white silver mirrors that have substantially uniform reflectance throughout the visible spectrum are of course extremely well known. It is an object of this invention to produce a mirror having a patterned appearance that may be informational or aesthetically desirable.

There are a number of patents describing application of non-metallic materials to both outer and inner sides of the mirror for decorative purposes. Decorative layers on the outer side of the mirror (U.S. Pat. No. 1,413,429) may be subject to deterioration from oxidation or corrosion by the environment. Decorative layers on the inner side affect the adhesion of the reflective layer to the glass substrate. U.S. Pat. NOs. 1,604,659 and 3,152,948 discuss different ways of sensitizing the surface to improve the adhesion.

U.S. Pat. No. 4,894,278 uses chemical agents to change the reflective properties of existing silver layer during the wet stage of silvering process. Since this process is hard to control it produces non-uniform patterns that are not suitable for small decorative elements or fine fonts.

### OBJECTS AND ADVANTAGES

Accordingly, several objects and advantages of the present invention are:
a) To provide a mirror with patterned appearance that may be decorative or informational or both;
b) To provide a mirror with such patterns that are not subject to corrosion or oxidation by the environment;
c) To provide a mirror with such patterns that may be small enough to form fine fonts and small decorative elements;
d) To provide a mirror with such patterns that feature uniform reflective properties across a pattern in order to facilitate the perception of the pattern shape.

### SUMMARY

According to the invention there is provided a decorative mirror comprising overlapping reflective metallic layers deposited on a transparent sheet. Overlapping layers will produce areas with different reflective properties. These areas make patterns that can be alphanumerical, or ornamental, or artistic or a combination of all for informational and decorative purposes. Process of manufacturing of such a mirror involves application of a mask, which prevents metal deposition, before each layer is deposited. The mask is removed after the layer is deposited thus making upper layers visible through the voids in the lower layers. Reflective layers may be protected with further layers, for example of varnish or paint.

### DESCRIPTION OF DRAWINGS

FIG. 1 shows a cross section of a decorative mirror comprising two reflective layers.

FIGS. 2 through 4 show cross sections of a decorative mirror on different stages of manufacturing.

FIG. 2 shows a transparent substrate with a mask.

FIG. 3 shows a substrate with a mask after first reflective layer has been deposited.

FIG. 4 shows a transparent substrate with first reflective layer after the mask has been removed.

### LIST OF REFERENCE NUMERALS

10—transparent substrate.
11—mask preventing metal deposition.
12—first reflective layer.
13—second reflective layer.
14—a void in the first reflective layer.
15—a transition over the mask edge.

### DESCRIPTION OF INVENTION

The invention describes a decorative mirror. This mirror features several overlapping and non-continuous reflective metallic layers with different reflective properties deposited on a transparent substrate. Areas where upper layers are visible through the voids in the lower layers make patterns that can be alphanumerical or ornamental or artistic or combination of all for informational and decorative purposes.

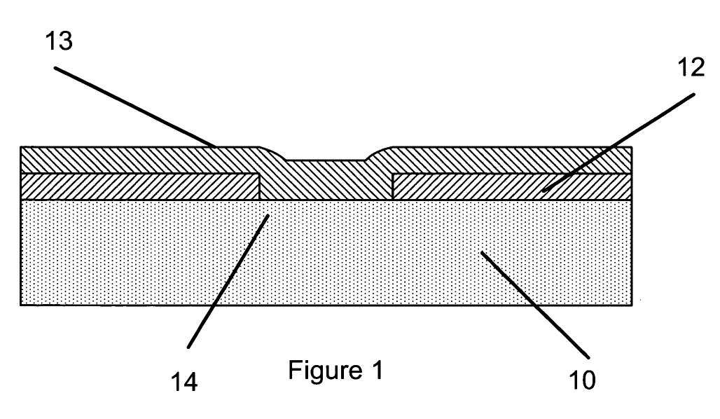

In preferred embodiments the first layer is made of silver and the second layer is continuous and is made of copper. This forms distinctive copper patterns visible through the voids in the silver mirror layer. An added advantage is that the copper layer protects a mirror layer from deterioration due to oxidation or corrosion by the environment. FIG. 1 shows a cross section of such mirror where copper layer 13 is visible through a void 14 in the silver layer 12 when looking through a transparent substrate 10.

In other embodiments other metals like nickel or gold may form the second layer to produce different decorative effects.

Additional embodiments of the invention, feature more than two metallic layers applied to a transparent substrate to produce patterned reflection that may be thought desirable. Finally all reflective layers may be protected with varnish or paint.

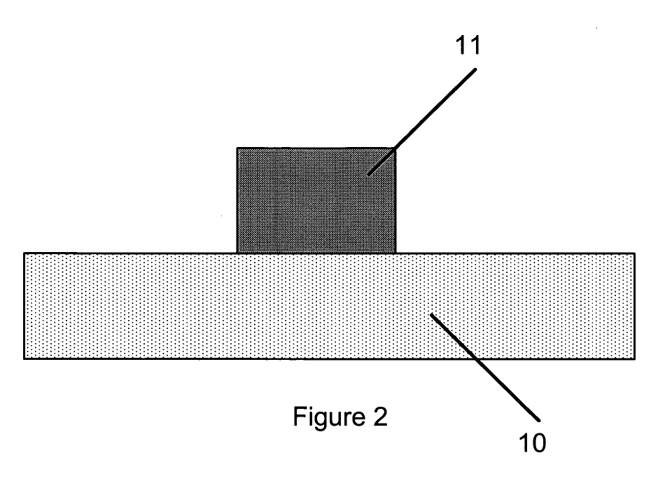

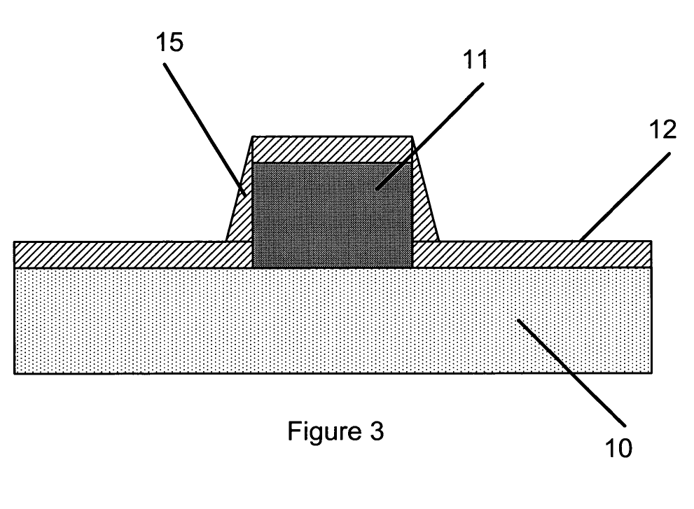

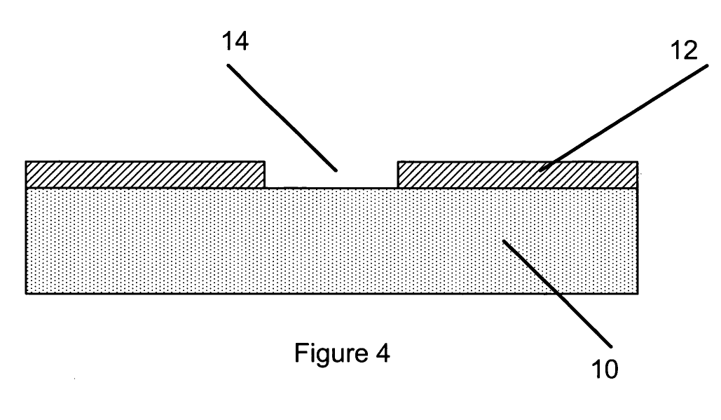

The invention includes a process of manufacturing a decorative mirror with patterned appearance. A mask preventing metal deposition is applied before every successive layer is deposited. FIG. 2 shows a mask 11 on the transparent substrate 10 before the first reflective layer is deposited. This mask represents a desired pattern or part of it. FIG. 3 shows the mirror after the first reflective layer 12 has been deposited on a substrate 10. The mask is removed after the layer is deposited as it is shown in FIG. 4. This makes next overlapping layer visible through the voids 14 in the underlying layer 12.

Various processes may be used to produce a mirror layer on a transparent substrate. The process should allow for a safe mask removal that does not disturb the corresponding metallic layer. In preferred embodiments of the invention, magnetron sputtering is such process.

Unlike well-known wet processes of mirror manufacturing magnetron sputtering produces very thin transitions over mask edges thus allowing a safe mask removal that does not damage the deposited layer. FIG. 3 shows transitions 15 over mask 11 edges after the first layer 12 has been deposited on a substrate 10. Another important advantage of magnetron sputtering in multi layer mirror manufacturing is its immunity to defects caused by the poor adjoining of mask edges. This imperfection lets the chemicals used in a wet process leak under the mask and damage the pattern.

### CONCLUSIONS, RAMIFICATIONS AND SCOPE

The decorative mirror, that is the subject of the invention and process of its manufacturing allow the creation of very fine patterns that represent small fonts or decorative elements. A uniform reflection of metallic layers facilitates pattern perception.

These mirrors can serve for promotional or advertising purposes. They can range in size from small pocket size articles to big wall mirrors.

While the description above contains much specificity, it should not be construed as limitations on the scope of the invention, but rather as an example of one preferred embodiment thereof. Many variations are possible. For example, the first reflective layer may be made out of other than silver metals; the protective varnish layer may also be a part of the desired pattern, etc.

Accordingly, the scope of the invention should be determined by the appended claims and their legal equivalents, rather than by the examples given.

1. A process of manufacturing a decorative mirror, comprising one or more repetition of the following steps:
a. application of a mask that prevents metal deposition to a transparent substrate;
b. deposition of a reflective layer;
c. removal of the mask.

2. A process according to claim 1, further comprising the step of coating the uppermost metallic layer with a protective coating of paint or varnish.

3. A decorative mirror made by a process according to claim 1.
